(19) United States
(12) Patent Application Publication
(10) Pub. No.: US 2013/0088220 A1
(43) Pub. Date: Apr. 11, 2013

(54) APPARATUS FOR NON-DESTRUCTIVE TESTING

(71) Applicants: Jonathan Johnson, Sheffield (GB); Robyn Aston, Berkshire (GB)

(72) Inventors: Jonathan Johnson, Sheffield (GB); Robyn Aston, Berkshire (GB)

(73) Assignee: JOHNSON & ALLEN LIMITED, Sheffield (GB)

(21) Appl. No.: 13/465,660

(22) Filed: May 7, 2012

(30) Foreign Application Priority Data
Oct. 6, 2011 (GB) 1117266.5

(51) Int. Cl. G01N 27/84

(52) U.S. Cl. 324/214

(57) ABSTRACT

Apparatus for MPI testing, the apparatus comprising a portable, body worn MPI system including an electromagnetic MPI electrode in wired communication with a DC power supply, via an AC inverter. The apparatus includes a body worn arrangement for carrying the electromagnetic MPI electrode, DC power supply and AC inverter hands free.

This disclosure relates to apparatus for use in non-destructive testing (NDT), more particularly, but not exclusively, for non-destructive testing using electromagnets. The invention also relates to methods of non-destructive testing (NDT) using electromagnets.

The term non-destructive testing (NDT) is used to describe methods of material analysis, in which the properties of material under test can be evaluated without causing damage to the material.

Magnetic particle inspection (MPI) is a specific form of NDT, wherein a magnetic field is induced in the material under test (e.g. a ferromagnetic material or alloy) and magnetic flux leakage is monitored, in order to identify surface or subsurface discontinuities in the material.

On a large scale, it is known to pass an electromagnetic device, commonly referred to as a pig, along the inside of a pipeline, for monitoring magnetic flux leakage in the walls of the pipeline. On a smaller scale, it is known to apply ferrous particles to a surface of a material under test, whereby the relative attraction of the ferrous particles on the surface of the material provides a visual indication of areas of magnetic flux leakage from the material.

Typically, small scale MPI testing is carried out in a laboratory, where there is suitable provision for generating the required magnetic field.

What is required is an MPI apparatus suitable for use in the field (i.e. away from the laboratory), more particularly for use difficult or restricted access locations, e.g. at points of elevation.

According to one aspect of the invention, there is provided an apparatus for magnetic particle inspection in accordance with claim 1.

According to another aspect of the invention, there is provided a portable MPI kit in accordance with claim 17.

According to a further aspect of the invention, there is provided a method of MPI testing in accordance with claim 19.

Other aspects and features of the invention will be apparent from the appended claims or the following description of exemplary embodiments, made by way of example only, with reference to the accompanying Figures, in which:

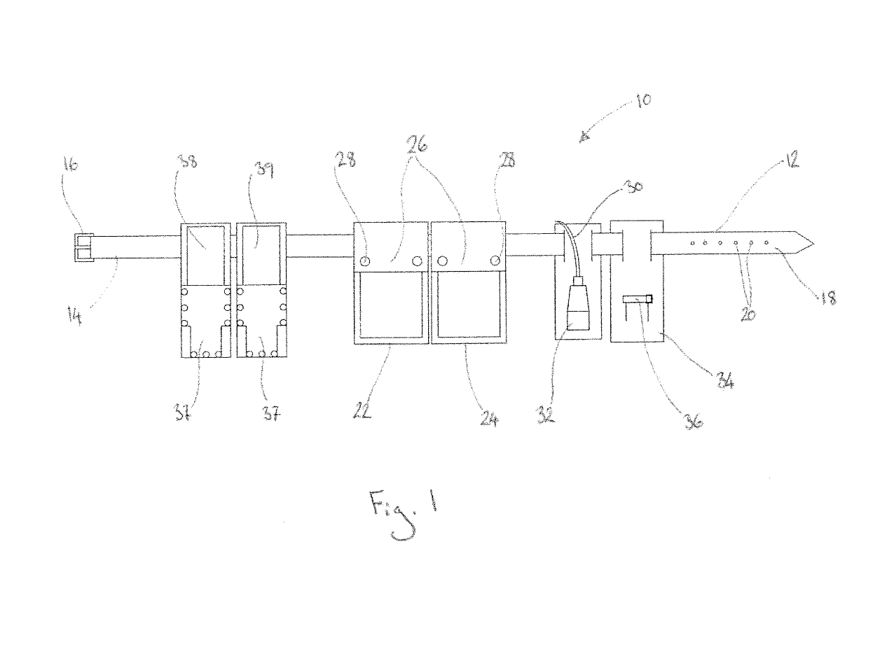

FIG. 1 is a schematic plan view of a belt for use in MPI testing applications;

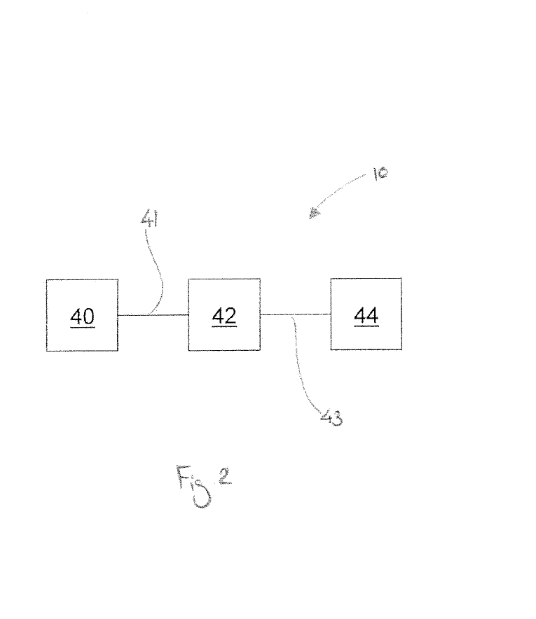

FIG. 2 is a schematic block diagram showing the main components of an MPI apparatus of FIG. 1;

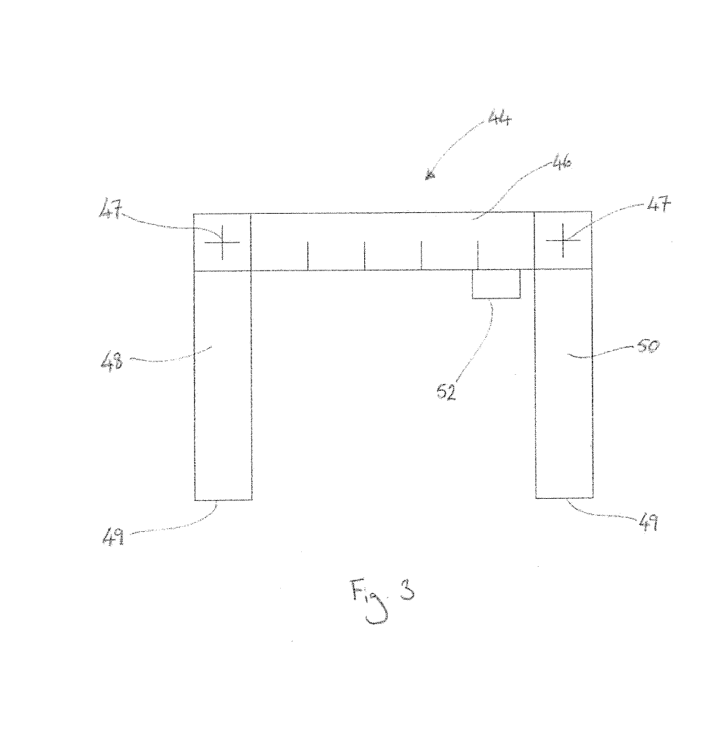

FIG. 3 is a schematic diagram of an example of an MPI electrode for use with the apparatus of FIG. 1;

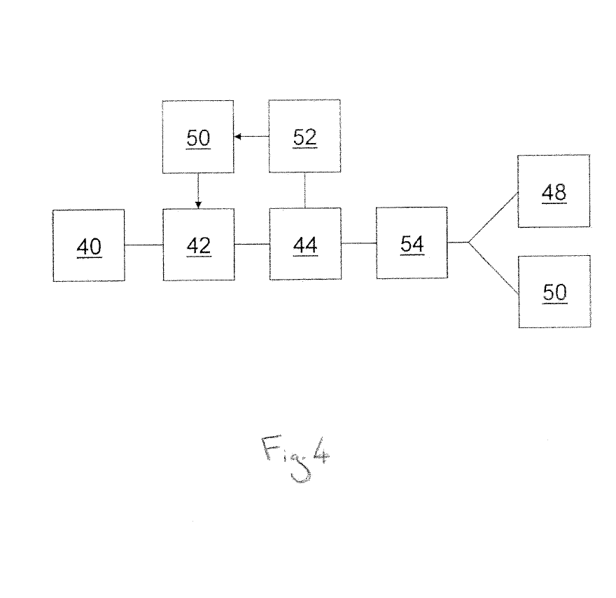

FIG. 4 is a schematic block diagram showing a circuit for powered operation of the apparatus;

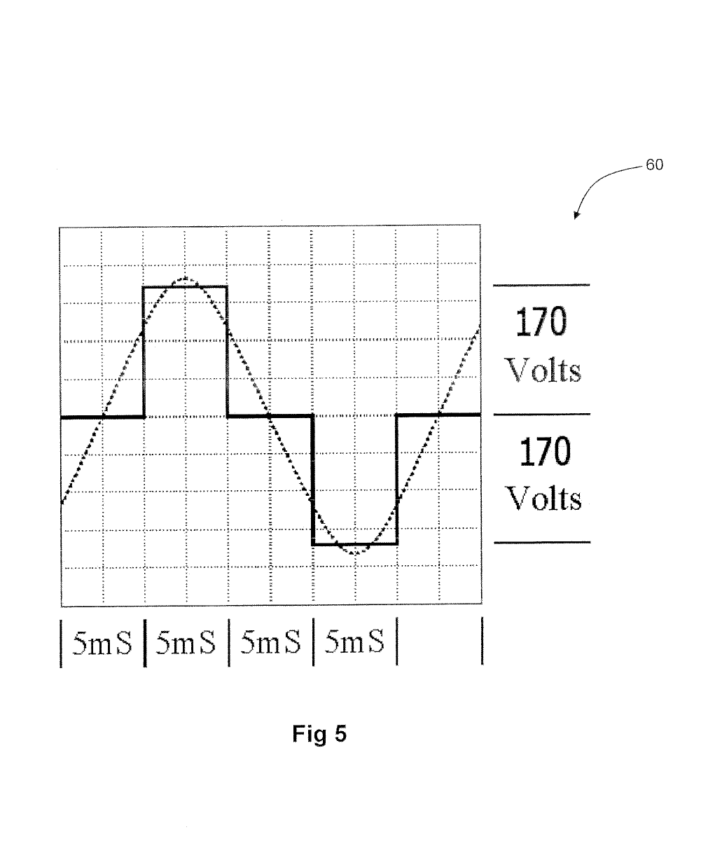

FIG. 5 is a diagram of an output generated by an inverter of an MPI apparatus of FIG. 1.

Referring firstly to FIG. 1, an apparatus for MPI testing is indicated generally at 10. The apparatus 10 takes the form of a belt 12, e.g. to be worn around the waist of an operative. The belt 12 is elongate, having a first end 14 with a buckle 16 and a second end 18 with apertures 20, so that the belt 12 can be adjustably secured on the operative in conventional manner.

The belt 12 includes first and second pouches 22, 24 that are slidably mounted on the belt 12. The first pouch 22 is configured to house a power pack (not visible in FIG. 1) and the second pouch is configured to house an inverter pack (not visible in FIG. 1). Each pouch 22, 24 includes a releasable closure 26 for securing the respective power supply/inverter in the pouch 22, 24 when the closure 26 is in a closed state (and for allowing removal and/or replacement of the respective power supply/inverter when the closure 26 is in an open state). In the illustrated embodiment, the closure 26 is in the form of a movable flap which can be secured in place in a closed state by the use of conventional snap fasteners 28.

The first and second pouches 22, 24 are located next to one another on the belt 12, and may be combined as a single pouch in alternative embodiments.

A power cable (not visible in FIG. 1) provides communication between the power supply and the inverter. A further power cable 30 extends from the inverter, for connection to an MPI electrode (not shown in FIG. 1). The power cable 30 includes a connector 32 of conventional form, for connection to the MPI electrode.

The belt 12 includes a holster 34 for releasably carrying the MPI electrode on the belt 12. The holster 34 includes a buckle and belt type fastener 36 for releasably securing the MPI electrode in the holster 34.

The belt 12 further one or more holders 37, e.g. for carrying a container 38 of magnetic ink (for use in MPI testing) and a container 39 of contrast spray (for aiding visual identification of an area under test) on the belt 12.

Accordingly, there is provided apparatus 10 for MPI testing, which is portable for use by a single operative, and consists of a self-contained MPI electrode and power supply arrangement, which can be body worn by a single operative in the field, so as to carried ‘hands free’, e.g. in elevated locations, such as on ladders. Individual components such as the power supply and inverter are carried in compartments 22, 24 on the belt 12.

FIG. 2 is a schematic drawing which shows the main parts of the portable MPI apparatus 10 referred to above.

The MPI apparatus 10 includes a DC battery pack 40, which serves as the main power supply for the apparatus 10. The DC battery pack 40 is arranged in wired communication with an AC inverter 42 (via cable 41), which is in turn arranged in wired communication with an electromagnetic MPI electrode 44 (via cable 43, e.g. corresponding to cable 30 in FIG. 1).

The MPI electrode 44 is shown schematically in FIG. 3, and includes main body 46 which functions as a handle, to be gripped by the operative during testing. The electrode 44 further includes first and second poles 48, 50, which can be energised for inducing a magnetic field in a material or component under test, e.g. a weld bead in a pipeline in the oil & gas industry.

In exemplary embodiments, the poles 48, 50 are movable relative to one another, e.g. for vary the spacing between their free ends 49. In the illustrated embodiment, the poles 48, 50 are pivotably connected to the main body 46, via a pivot points 47.

In exemplary embodiments, the MPI electrode 44 includes an electromagnet (not shown) and an activation mechanism for selectively energising the poles 48, 50. In the illustrated embodiment, the activation mechanism is in the form of a trigger 52 (e.g. a switch, lever or button or the like on the main body 46) which can be operated to energise the poles 48, 50 on demand.

In exemplary embodiments, the battery pack 40 and inverter 42 are small enough to be belt mounted, e.g. for mounting in respective pouches or compartments on a waist-worn belt of the kind shown in FIG. 1. In other embodiments, the battery pack 40 and inverter 42 are mounted in respective compartments on a harness or other body worn arrangement such as a rucksack (e.g. instead of the belt 12). In each case, the MPI apparatus 10 is advantageously portable and allows for hands-free transport of the electrode 44 and power supply 40, 42 by a single operative in the field, e.g. as the operative ascends to an elevated test location (such as up ladders). Typically, the apparatus 10 will have a weight not exceeding 15 kg.

In exemplary embodiments, the body worn MPI apparatus 10 is configured to provide 110 volt 50-60 Hz AC current to the MPI electrode.

In exemplary embodiments, the power supply takes the form of a lithium polymer battery pack 40. In exemplary embodiments, the inverter 42 is configured for changing 12 volts DC to 110 volts 50-60 Hz AC. In exemplary embodiments, the inverter 42 generates a quasi-sine wave output 60, as illustrated in FIG. 5. The wave shown in FIG. 5 is an AC output at 110 volts and 50 Hz.

In exemplary embodiments, the apparatus 10 is provided with an electrical socket configured to be compatible for connection and use with portable 110 volt equipment

In exemplary embodiments, the inverter 42 is configured to deliver a higher frequency output (i.e. beyond conventional UK 50-60 Hz mains frequencies). In exemplary embodiments, the inverter 42 is configured to deliver an output above 50 Hz and up to about 500 Hz.

Providing as high output frequency in conjunction with an MPI electrode 44 has the advantage of creating a heightened ‘skin’ effect during surface magnetisation of the object under test. This gives an improved particle migration and thus and improved defect indication.

Use of a higher frequency output makes it possible to produce lighter, easier to use MPI electrodes. For example, it is possible to provide an MPI electrode 44 of reduced specification (e.g. in terms of the number of coils and laminations), whilst maintaining an adequate magnetising effect on the surface of the object under test suitable to undertake an MPI test operation. Hence, it is possible to reduce the size and weight of the MPI electrode 44, if the electrode is powered by an inverter 42 with a high output frequency (e.g. 500 Hz).

In exemplary embodiments, the apparatus 10 includes stand-by circuitry for controlling on/off operation of the electrode 44 without the need for a dedicated on/off switch for the power supply. An example of such stand-by circuitry is shown schematically at 50 in FIG. 4

The stand-by circuitry 50 is configured to operate a stand-by mode in which only a small current (e.g. in milli amps) is supplied from the battery 40 (i.e. via the inverter 42) to the MPI electrode 44 when the MPI electrode is inactive.

When the trigger 52 is operated, the stand-by circuitry 50 is configured to recognise an imbalance, indicative that there is a demand for power to the electrode 44. In response, the circuitry 50 automatically switches the inverter on, so that full current can be supplied to the electrode 44. Similarly, the stand-by circuitry 50 is configured to detect when the electrode 44 returns to an inactive state (e.g. when there is no demand for power to the electrode 44 via the trigger 52), in order to return the inverter 42 to the stand-by mode.

The stand-by circuitry 50 prolongs the life of the battery 40. It also avoids the need for disconnection of the electrode 44 from the inverter when the electrode is not in use, and obviates the need for a dedicated on/off switch for the inverter 42.

The stand-by circuit is particularly advantageous for the portable, body worn MPI apparatus 10, since the operative is able to use or stow the electrode 44 without operating multiple switches to turn the apparatus on/off between testing operations. This is particularly advantageous for elevated testing operations and the like, where the operative may require 3 points of contact on a ladder or other support.

In exemplary embodiments, the apparatus 10 includes safety circuitry indicated at 54 in FIG. 4. The safety circuitry 54 is configured to limit the initial supply of current to the electrode 44. This is because such electrodes 44 may be prone to inductive loads which can cause an inrush of high current initially within the first seconds of activating the electrode (e.g. via the trigger 52). Such situations can, if not controlled, cause safety protection circuits of lithium batteries to cut out. The safety circuitry 54 of exemplary embodiments is configured to prevents or limit such an inrush of current to the electrode 44, and thereby prevent a spike in initial start up demand of current from the battery 40. This prevents unwanted tripping the battery safety circuits and is also better for the life of the battery 40.

An exemplary method of operation of the apparatus 10 by a lone operative at a remote testing location will now be described, e.g. for use in detecting cracks or other surface breaking discontinuities/defects in a weld bead in a pipe line.

Firstly, the operative puts on the belt 12, so that the battery pack 40, inverter 42 and MPI electrode 44 are carried by the belt and the operative is able to move ‘hands free’ in relation to the apparatus 10. The operative is thus able to ascend a ladder or the like, in order to reach an elevated test location, unhindered by the apparatus 10.

Typically, a section of material or component under test will then be sprayed with a contrast spray 39 (to aid visualisation of the area under test), e.g. as carried in one of the holders 38 on the belt 12. A conventional micro-fine iron oxide fluid suspension or other such magnetic ink 38 (e.g. as carried on the belt 12) is also applied to the surface of the area under test.

If not already removed, the operative removes the electrode 44 from the holster 34 and positions the poles 48, 50 of the electrode 44 in contact with the material under test. The trigger 52 is operated, whereby the standy-by circuit switches to the normal operation mode, in order to allow the electromagnet to become energised, for inducing a magnetic field in the material under test.

Dependent upon the orientation of the electrode 44, one side of any local crack or other surface breaking discontinuity in the material will serve as a north pole and the other side of said crack or discontinuity will serve as a south pole, with the effect that any leakage or “extraneous” field will loop out from any significant crack/discontinuity in the surface under test. Ferrous particles in the magnetic ink will be attracted to “build up” or aggregate in the region of any crack/discontinuity in the material, thereby providing a visual contrast to the surrounding area, in order to highlight cracks and other discontinuities in said area.

The use of an AC power supply for the electrode (via the AC inverter) is particularly advantageous for generating AC magnetic fields capable of finding finer surface breaking discontinuities (e.g. fine cracks) in a test area of a ferrite material/component than is possible using conventional portable DC devices. This is because AC magnetisation tends to be greatest at the surface of a material or component under test. Moreover, the continually reversing polarity of AC magnetisation serves to shuffle and agitate the micro ferrous particles in the magnetic ink, which aids migration of the particles to areas of leakage.

Although the illustrated embodiment shows a belt-mounted MPI apparatus, the MPI apparatus may alternatively be mounted on a body worn harness or other arrangement intended to be worn by a single operator, so that the single operator is able to use the apparatus in the field, e.g. in elevated locations, such as on ladders. In each case, the power supply, inverter and electrode are intended to be carried on the body worn arrangement, together with the magnetic ink and contrast spray in exemplary embodiments.

The result is a self-contained and portable AC MPI system configured to be body worn for field inspection of surface breaking defects in ferrite materials, such as in weld beads in pipelines.

Although described with particular reference to MPI testing apparatus including a portable, hand-held electromagnetic MPI electrode, the concepts described herein may be applicable to operation of other hand held devices, such as drills, branding irons, industrial hair shearing devices.

1. Apparatus for MPI testing, the apparatus comprising a portable, body worn MPI system including an electromagnetic MPI electrode in wired communication with a DC power supply, via an AC inverter, wherein the apparatus includes a body worn arrangement for carrying the electromagnetic MPI electrode, DC power supply and AC inverter hands free, wherein the electromagnetic MPI electrode comprises an electromagnet and includes a manually operable activation mechanism configured to allow a user to selectively energise the electromagnet via the DC power supply and AC inverter, and wherein the electrode is configured to operate between a stand-by mode and a normal operation mode, dependent upon the state of operation of the activation mechanism.

2. Apparatus according to claim 1 wherein the apparatus includes stand-by circuitry for controlling operation of the electromagnetic MPI electrode between said stand-by mode and said normal operation mode.

3. Apparatus according to claim 2 wherein the stand-by circuitry is configured to operate a stand-by mode in which only a small current (e.g. in milli amps) is supplied from the DC power supply to the electromagnetic MPI electrode, via the AC inverter, when the electromagnetic MPI electrode is inactive.

4. Apparatus according to claim 2 wherein the stand-by circuitry is configured to switch from said stand-by mode to said normal operation mode (e.g. in which full current may be supplied to the electromagnetic MPI electrode) upon a demand for power to the electrode (e.g. via operation of the activation mechanism).

5. Apparatus according to claim 1 wherein the activation mechanism includes a manually operable trigger mechanism configured to be moved from a first position in which the MPI electrode is held in said stand-by mode and a second position in which the electrode is energised for said normal operation mode.

6. Apparatus according to claim 5 wherein the apparatus includes stand-by circuitry configured to switch from said stand-by mode to said normal operation mode upon movement of said trigger mechanism from said first position to said second position.

7. Apparatus according to claim 2 wherein the stand-by circuitry is configured to return to said stand-by mode from said normal operation mode when the activation mechanism is inactive or when the electromagnet is inactive.

8. Apparatus according to claim 1 wherein the apparatus includes safety circuitry configured to regulate or limit the initial supply of current to the electrode upon activation of the activation mechanism.

9. Apparatus according to claim 8 wherein the safety circuitry is configured to avoid a significant spike in the initial start up demand of current from the power supply.

10. Apparatus according to claim 1 wherein the DC power supply is separate from and in wired communication with the AC inverter.

11. Apparatus according to claim 10 wherein the DC power supply is carried in a compartment on the body worn arrangement.

12. Apparatus according to claim 11 wherein the AC inverter is separate from the DC power supply and is carried in a dedicated compartment on the body worn arrangement.

13. Apparatus according to claim 1 wherein the body worn arrangement includes a holster or compartment for carrying the MPI electrode hands free.

14. Apparatus according to claim 1 wherein the body worn arrangement comprises a belt to be worn around the waist of an operative, and wherein the DC power supply and AC inverter are carried in respective compartments on the belt.

15. Apparatus according to claim 1 wherein the apparatus has a weight in the region of 10-20 kg, e.g. not exceeding 15 kg.

16. Apparatus according to claim 1 wherein the body worn arrangement further includes a holder for carrying a container of magnetic ink.

17. Apparatus according to claim 1, wherein the AC inverter is configured to deliver an output above 50 Hz and below 500 Hz.

18. Apparatus according to claim 1, wherein the AC inverter is configured to output a quasi-sine wave.

19. Portable MPI testing kit comprising a portable power supply, an electromagnetic MPI electrode arranged in communication with said portable power supply, wherein the kit further includes an arrangement configured to be worn on the body of a user, wherein said arrangement comprises one or more of a belt, harness or rucksack intended to be worn on the body of a user and configured to enable an operator to carry the portable power supply and electromagnetic MPI electrode hands free.

20. Portable MPI testing kit according to claim 19 wherein the portable power supply includes a DC supply in communication with an AC inverter.

21. Portable MPI testing kit according to claim 19 further comprising a container of magnetic ink, and wherein the arrangement is further configured for carrying the container of magnetic ink hands free, power supply and electrode hands free.

22. A method of MPI testing, the method comprising the initial step of an operator carrying a portable MPI system comprising an electromagnetic MPI electrode in wired communication with a DC power supply via an AC inverter, the method comprising the further steps of the operator moving to a remote field site, by hand placing the MPI electrode in contact with a material or component under test at said remote field site, and using the DC power supply to energise the electrode via the AC inverter, in order to induce a magnetic field in the material or component under test.

23. The method according to claim 22 wherein the electrode comprises an electromagnet and includes a trigger mechanism for selectively energising the electromagnet via the DC power supply and AC inverter, and wherein the apparatus is configured to switch between a stand-by mode in which minimal current is supplied to the electrode when the trigger mechanism is inactive and a normal operation mode when the trigger mechanism is active.

24. The method according to claim 23 wherein the method includes the step of providing the operator with a body-worn arrangement configured to be worn on the body of the operator and comprising one or more of a belt, harness or rucksack intended to be worn on the body of a user and configured to enable the operator to carry the portable power supply and electromagnetic MPI electrode hands free.
